(19) United States
(12) Patent Application Publication
(10) Pub. No.: US 2007/0182677 A1
(43) Pub. Date: Aug. 9, 2007

(54) Vehicle display configuration and method of controlling a display

(75) Inventors: Jonathan Lee, Puyallup, WA (US); Daniel Rosario, Santa Cruz, CA (US); Arne Stoschek, Palo Alto, CA (US)

Correspondence Address: MANFRED BECK, P.A., 830 TYLER STREET, HOLLYWOOD, FL, 33019-1327, US

(73) Assignee: Volkswagen of America, Inc.

(21) Appl. No.: 11/347,934

(22) Filed: Feb. 6, 2006

(51) Int. Cl. G09G 3/32

(52) U.S. Cl. 345/82

(57) ABSTRACT

A vehicle display configuration includes an LED (light emitting diode) display with a flexible circuit board and a plurality of LEDs mounted on the flexible circuit board. The flexible circuit board conforms to the surface shape of a mounting layer to which it is fastened. A control circuit which includes a driver circuit is operatively connected to the LEDs for controlling the LEDs. The driver circuit has a serial data input and a shift register. The driver circuit shifts data received via the serial data input into the shift register and controls the LEDs in accordance with the data in the shift register. A method of controlling a display is also provided.

### BACKGROUND OF THE INVENTION

### Field of the Invention

The invention relates to a vehicle display configuration, in particular to a display with light emitting diodes (LEDs) for automotive applications, and to a method of controlling an LED display.

LEDs are increasingly used as a replacement for conventional incandescent lamps in cars. For example, LEDs are used in rear lights of cars. General advantages of LEDs over conventional incandescant lamps are their small size, their energy efficiency and their long life expectancy.

Depending on the specific applications in which LEDs are used, it may be necessary to drive the LEDs with a control circuit. For example, if it is desired to have LEDs with an adjustable brightness, the control circuit must be able to control the LEDs such that the brightness can be adjusted to various levels.

For some applications, LEDs are mounted on a circuit board and a row-column method of driving the LEDs is used. This row-column driving method, configured to reduce the number of wires required for a dot-matrix LED control, is achieved by creating a grid of LED connections by which LEDs are pulsed at a high current for a short period of time. A disadvantage of the row-column driving method is that the controllability is limited because only a single LED may be uniquely addressed at a time. As a consequence, it is not possible to simultaneously control the brightness of each individual LED.

According to another method, it is possible to control the brightness over an entire display of LEDs that are mounted on a circuit board. In this case the control is based on varying the supply voltage for the LED display similar to a dimmer switch on a household light. A disadvantage of this solution is that the brightness control affects all LEDs of the display and brightness is shared among all LEDs within the display. It is thus not possible to control individual LEDs or LED segments.

Several U.S. patents disclose the use of LEDs as light sources. U.S. Pat. No. 6,299,337 B1 discloses a flexible multiple LED module having a plurality of rigid printed circuit boards which are connected to one another via a flexible printed circuit board. The LED module has a given flexibility due to the flexible circuit boards provided between the rigid circuit boards.

U.S. Pat. No. 6,657,767 B2 discloses a rearview mirror assembly with LEDs mounted on a flexible circuit board behind the mirror. The LEDs are controlled together and are used as a turn signal indicator.

U.S. Pat. No. 6,652,128 B2 discloses a backlighting method for an automotive trim panel. The trim panel is perforated and a light source is mounted behind the trim panel. An LED incorporated in a flexible printed circuit may serve as the light source.

U.S. Pat. No. 6,158,882 discloses an LED semiconductor lighting system for illuminating vehicle interiors. The lighting system includes a light tube with LEDs inside the light tube. The illumination intensity of the LEDs is controlled by a dimming module.

### SUMMARY OF THE INVENTION

It is accordingly an object of the invention to provide a vehicle display configuration which overcomes the above-mentioned disadvantages of the heretofore-known vehicle display configurations of this general type and which provides an improved control of individual LEDs or segments of an LED display, in particular their on-off states and their brightness, and which allows a versatile mounting of the LEDs on irregular or non-planar surfaces, in particular on curved surfaces of a vehicle, and which can endure environmental conditions typical for automotive applications. A further object of the invention is to provide a method for controlling an LED display.

With the foregoing and other objects in view there is provided, in accordance with the invention, a vehicle display configuration, including:

a mounting layer having a surface shape;

an LED display including a flexible circuit board and a plurality of LEDs mounted on the flexible circuit board;

the flexible circuit board conforming to the surface shape of the mounting layer;

a control circuit including a driver circuit operatively connected to the LEDs for controlling the LEDs;

the driver circuit having a serial data input and a shift register, the driver circuit shifting data received via the serial data input into the shift register; and

the driver circuit controlling the LEDs in accordance with the data in the shift register.

Advantages of the above-defined vehicle display configuration are that it can be mounted on irregular mounting surfaces, that it conforms to the curvature of the mounting surface and that the on-off states and the brightness of the individual LEDs can be independently controlled. The vehicle display configuration increases the number of surfaces that are suitable for mounting light sources and provides the ability to produce a variety of lighting effects, display graphics or text.

According to another feature of the invention, the control circuit includes a microcontroller connected to the driver circuit for sending data to the serial data input of the driver circuit. Using a microcontroller for providing control data is advantageous because a microcontroller allows implementing a variety of features such as dimming, visual effects, or display graphics. The term microcontroller is understood as a broad term that covers not only dedicated controllers but also covers other types of controllers such as computers or digital signal processors.

According to yet another feature of the invention, the driver circuit is an integrated circuit mounted on the flexible circuit board. Providing the driver circuit on the flexible circuit board simplifies the installation of the vehicle display configuration.

According to yet another feature of the invention, the driver circuit is a first driver circuit connected to a first group of the LEDs mounted on the flexible circuit board; the control circuit includes a microcontroller and includes a second driver circuit connected to a second group of the LEDs mounted on the flexible circuit board; the first driver circuit and the second driver circuit each have a serial data input, a serial data output and a shift register; the serial data input of the first driver circuit is connected to the microcontroller for receiving data from the microcontroller; the serial data input of the second driver circuit is connected to the serial data output of the first driver circuit for receiving data cascaded through the first driver circuit; the first driver circuit and the second driver circuit respectively shift data received via the serial data input into the shift register; and the first driver circuit and the second driver circuit respectively control the first group and the second group of the LEDs in accordance with the data in the shift register. An advantage of cascading the driver circuits is that it allows controlling a plurality of driver circuits and thus allows controlling an increased number of LEDs.

According to a further feature of the invention, the control circuit adjusts a brightness of the LEDs by switching the LEDs on and off in a recurring pattern. An advantage of controlling the brightness by switching the LEDs on and off, rather than adjusting the brightness by adjusting a supply voltage to the LEDs, is that a color shift or wavelength shift of the LEDs can be avoided.

According to a further feature of the invention, the flexible circuit board is coated with a protective material such as polyurethane, acrylic, plastic, rubber or an electromagnetic interference shielding material. A protective layer is advantageous in order to protect the display from moisture, corrosive agents, mechanical pressure or ultraviolet light.

According to a yet further feature of the invention, a liner material at least partially covers the LED display, the LEDs emit light through the liner material; and the liner material is a vehicle roof liner material, a vehicle seat cover material, a vehicle interior panel material or a vehicle dashboard material. Mounting the LED display behind a liner allows creating aesthetically pleasing lighting sources and lighting effects.

According to another feature of the invention, the flexible circuit board is fastened to the mounting layer with a fastening element such as a retaining clip, a hook and loop fastener or an adhesive. An advantage of fastening the circuit board with an adhesive is that no mechanical fastening structures on the mounting layer are necessary.

According to another feature of the invention, the mounting layer is translucent and the flexible circuit board includes translucent lead lines. This feature allows integrating an LED display into a window glass.

According to yet another feature of the invention, the mounting layer is a vehicle component such as a gear shifter, a door handle or a vehicle key.

According to another feature of the invention, an electronic element such as a push button or a sensor element is mounted on the flexible circuit board. This feature advantageously allows mounting pushbuttons or sensors on surfaces without requiring mounting structures such as mounting brackets, mounting holes or the like.

According to yet another feature of the invention, the flexible circuit board is configured to have no through-hole components mounted thereon. An advantage of an LED display according to the invention which has no through-hole components is that they can endure higher levels of mechanical stress and vibration without being damaged.

With the objects of the invention in view there is also provided, a method of controlling a display, which includes the steps of:

providing cycle periods and controlling an LED by switching the LED at each cycle period into an on-state or an off-state;

providing N bits for controlling the on-state and the off-state of the LED, N being an integer greater than 2;

controlling the on-state and the off-state of the LED by repeatedly performing steps a) and b) starting with n=1 and increasing n by 1 until n=N:
a) switching the LED into an on-state or an off-state in accordance with an n−th one of the N bits; and
b) waiting for a time period corresponding to 2ⁿ⁻¹ cycle periods.

Another mode of the method of the invention includes creating a recurring interrupt pattern waveform by continuously repeating the steps a) and b) for n=1 to n=N; and using the recurring interrupt pattern waveform for continuously controlling the LED. An advantage of controlling an LED display with a recurring interrupt pattern waveform is that the LEDs can be controlled with respect to their brightness and that a variety of lighting effects can be generated such as a pulsating heartbeat effect or the effect of a propagating wave.

Other features which are considered as characteristic for the invention are set forth in the appended claims.

Although the invention is illustrated and described herein as embodied in a vehicle display configuration and a method of controlling a display, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of a vehicle display configuration according to the invention;

FIG. 2 is a diagrammatic top plan view of an exemplary embodiment of an LED display according to the invention;

FIG. 3 is an enlarged diagrammatic partial top plan view of an exemplary embodiment of an LED display according to the invention;

FIG. 4 is an enlarged diagrammatic partial top plan view of an exemplary embodiment of an LED display including a push button and a sensor according to the invention;

FIG. 5 is a diagrammatic partial sectional view of an embodiment of a vehicle display configuration according to the invention;

FIG. 6 is a diagrammatic partial sectional view of a further embodiment of a vehicle display configuration with a liner material on the display according to the invention;

FIG. 7 is a diagrammatic partial sectional view of another embodiment of a vehicle display configuration with retaining clips for fastening the LED display according to the invention;

FIG. 8 is a schematic simplified circuit diagram for illustrating the layout and control of the LED display according to the invention;

FIG. 9 is a graph illustrating an exemplary waveform for controlling the on-off states of LEDs of a vehicle display configuration according to the invention;

FIG. 10 is a graph illustrating a recurring interrupt pattern waveform for controlling a display in accordance with the invention;

FIG. 11 is a graph illustrating a further recurring interrupt pattern waveform for controlling a display in accordance with the invention; and

FIG. 12 is a flow chart illustrating the method of controlling a display in accordance with the invention.

### DESCRIPTION OF THE PREFERRED EMBODIMENTS

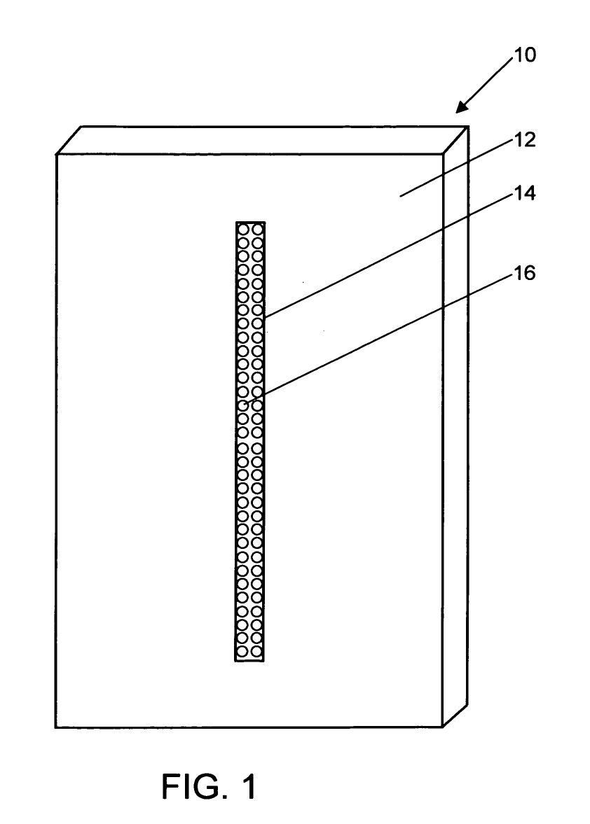

Referring now to the figures of the drawings in detail and first, particularly, to FIG. 1 thereof, there is shown a diagrammatic partial perspective view of a vehicle display configuration 10. The vehicle display configuration 10 includes a mounting layer 12 on which an LED (light emitting diode) display 14 is mounted. The mounting layer 12 can be any surface in or on a vehicle. The LED display 14 includes a plurality of LEDs 16. FIG. 1 shows a configuration that includes two columns of LEDs 16. The number of columns and rows of LEDs can be adapted to specific requirements. For example, if the mounting location is long and narrow, the LED display 14 may include only a single column of LEDs 16. If the mounting location has the shape of square, the number of columns of LEDs may be equal to the number of rows of LEDs. The mounting layer 12 shown in FIG. 1 has a flat surface. The mounting layer 12 may however also be a curved, uneven or otherwise irregular surface and may even be a flexible surface. For example, the roof lining of a vehicle, the interior door panels, the vehicle dashboard, the A-pillar, B-pillar or C-pillar, the vehicle chassis or seating surfaces of the vehicle may serve as the mounting layer 12.

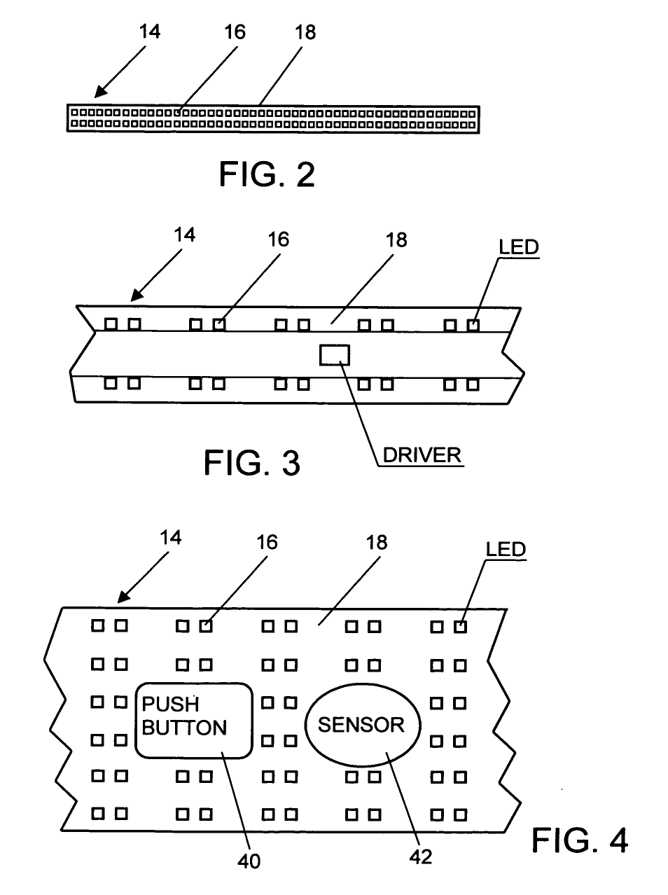

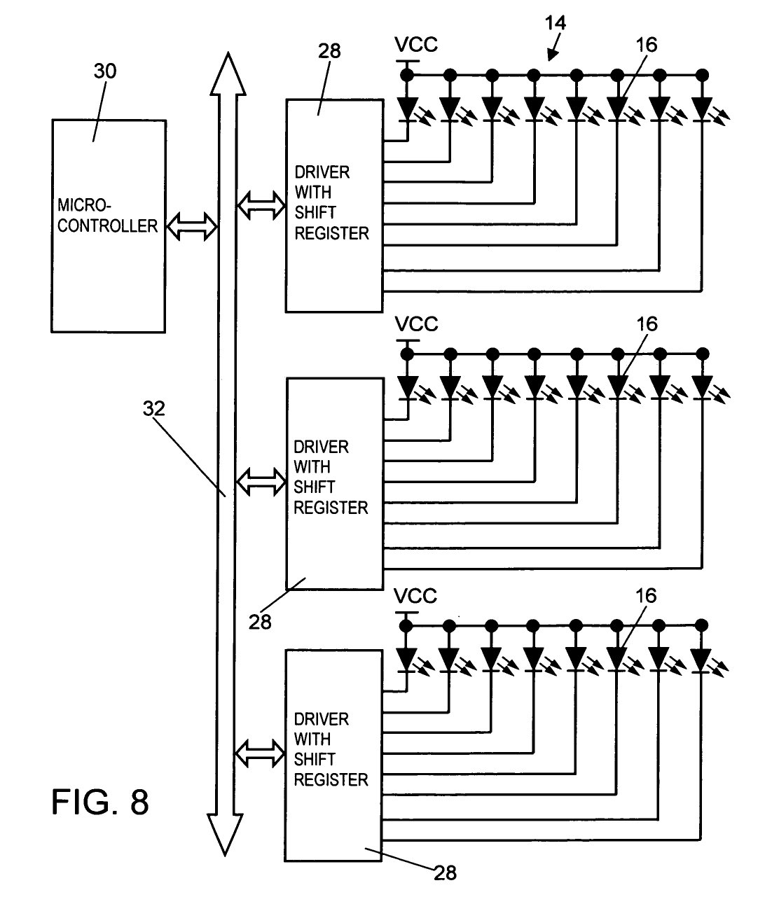

FIG. 2 is a diagrammatic top plan view of an exemplary embodiment of an LED display 14 which is configured as a flexible LED strip display 14. The flexible LED strip display 14 shown in FIG. 2 has for example a total length of about 600 mm with the LEDs 16 spaced at about 12.5 mm along its length. The two rows of LEDs 16 that extend along the length of the flexible LED strip display 14 are parallel to one another and are spaced about 10 mm from one another. The flexible LED display 14 includes 96 LEDs 16 with full on-off control and independent brightness control for each LED 16. The LEDs 16 in the exemplary embodiment are for example right angle LEDs. LED driver circuits 28 which include high speed shift registers are mounted on a polyamide material circuit board 18. Further discrete components may also be mounted on the circuit board 18. The operation of the driver circuits 28 with the shift registers and the operation of a microcontroller 30 connected to the driver circuits 28 is described in more detail with reference to FIG. 8.

The LED display 14 which is shown in FIG. 2 as having a continuous flexible circuit board 18 may alternatively be divided into segments for ease of construction. The flexible circuit board segments may be connected to one another by an integrated flex cable connector and encased in a low durometer, highly flexible polyurethane.

The LED display 14 emits for example white light in a uniform manner for an exterior parking light, warning display, interior ambient light, map light or accent light. LEDs of any color may be substituted into the display, as well as a combination of colors or discrete multi-color LEDs.

By controlling the on-off states of the LEDs 16, the LED display 14 can be used to create the impression of movement, visual cues or effects based in the state of the vehicle. For example, the LEDs 16 may flash in the event of a sudden stop, create an indicative motion left-right based on turn signals, brighten when the vehicle transmission is in park, react to the accelerator, or pulsate with the music playing on the vehicle's stereo. The LEDs may further be controlled to be turned on or off in a given sequence, for example starting at one end of the display and propagating to the other end of the display. A pulsating heartbeat effect, whereby all LEDs are simultaneously dimmed on and off, can also be created. It is further possible to create a wave-like effect, where each LED pulsates with a phase offset to create a chasing or traveling pattern. The direction and speed of travel may be chosen as desired.

In a vehicle, an LED display may be mounted beneath a fabric roof liner and extend from the front of the vehicle to the rear of the vehicle. When such an LED display is switched off, it may be controlled such that the illumination fades starting in the front of the vehicle and the fading effect propagates to the rear of the vehicle.

FIG. 3 is an enlarged diagrammatic partial top plan view of an exemplary embodiment of an LED display 14 which is configured as a flexible LED strip display 14. The LEDs 16 are mounted on a flexible circuit board 18 which is preferably made from polyamide in order to be sufficiently pliable to follow the curvature of essentially any interior or exterior surface of a vehicle. A driver circuit 28, which is embodied as an integrated circuit, is also mounted on the flexible circuit board 18 and is connected to the LEDs 16 in order to control the LEDs 16. The use of the flexible circuit board 18 described here is not limited to bendable strip displays 14. Rather, the flexible circuit board 18 can be utilized to mount LEDs in any configuration, orientation or shape. Further, switches or controls can be mounted on the flexible circuit board 18. The flexible circuit board 18 can also be utilized to provide a flat wiring harness with connectors.

In principle any PCB (printed circuit board) may be constructed as a flexible circuit, however, it was found that through-hole components, which are regarded as the most stable of PCB components, are unsuitable for mounting on the flexible PCB 18.

Mechanical stress and vibration may cause a stretching and tearing of the flexible polyamide PCB 18. As a result, pad separation becomes a problem with through-hole components. Thus, the flexible circuit board 18 is preferably configured to have no through-hole components mounted thereon.

In order to prevent damage to the flexible LED display 14, which may be caused by corrosive agents, ultraviolet light, dust, moisture or mechanical stress, it is advantageous to coat or encase the flexible circuit board 18 with polyurethane. In order to protect the flexible circuit board 18 from radio frequency (RF) interference or noise, it is advantageous to paint the flexible circuit board 18 with an RF or noise shielding material.

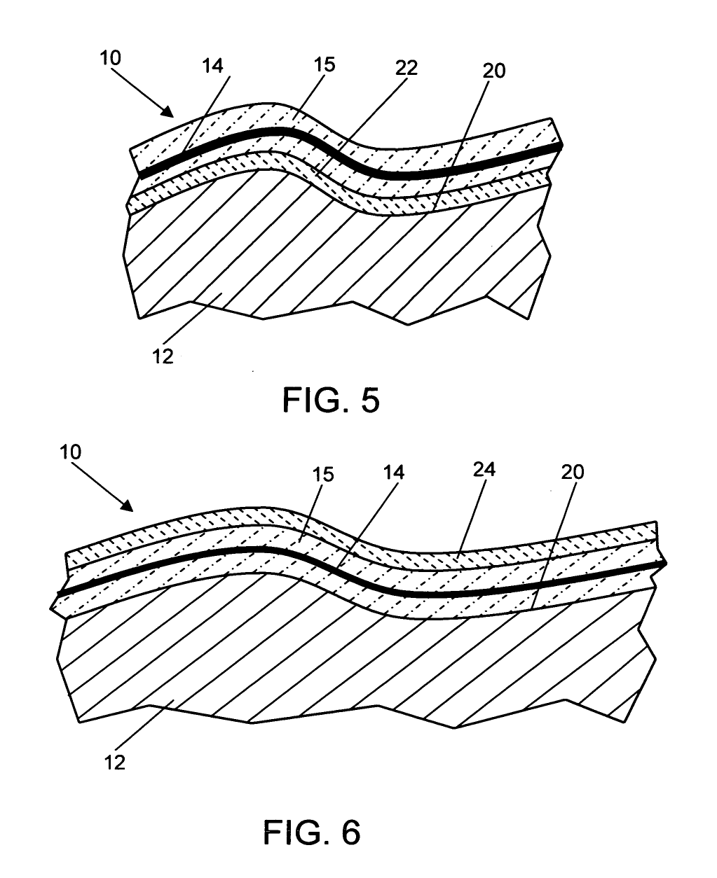

FIG. 4 is an enlarged diagrammatic partial top plan view of an exemplary embodiment of an LED display including a push button 40 and a sensor 42 mounted on the flexible circuit board 18. Integrating electronic devices such as buttons or sensors on the flexible circuit board 18 allows mounting electronic devices on surfaces without requiring special mounting structures such as mounting brackets or mounting holes. This makes it possible to manufacture curved instrument clusters, window or door lock control surfaces or backlighting of flexible displays in a cost-efficient manner.

FIG. 5 is a diagrammatic partial sectional view of a vehicle display configuration 10 according to the invention. The mounting layer 12 has a mounting surface 20. The mounting layer 12 may in principle be any vehicle component on which an LED display 14 is to be installed. The mounting layer 12 can therefore not only be a vehicle roof, a vehicle door panel or dashboard panel but can also be a gear shifter, a door handle or a vehicle key.

The flexible LED display 14 is coated or cast in a protective layer 15 and is disposed on the mounting surface 20 with an adhesive layer 22 provided between the mounting surface 20 and the flexible LED display 14. As can be seen in FIG. 5, the flexible LED display follows the contour of the mounting layer 12. Using an adhesive layer 22 for mounting the flexible LED display 14 is advantageous because no mounting brackets or other mechanical fastening elements, which require mechanically stable mounting positions, are necessary. The term adhesive layer 22 is understood as including not only a glue layer 22 but also other layers that cause the flexible LED display 14 to adhere to the mounting layer 12. For example, an adhesive layer 22 may be formed by a hook and loop fastener which is available under the trademark name VELCRO.

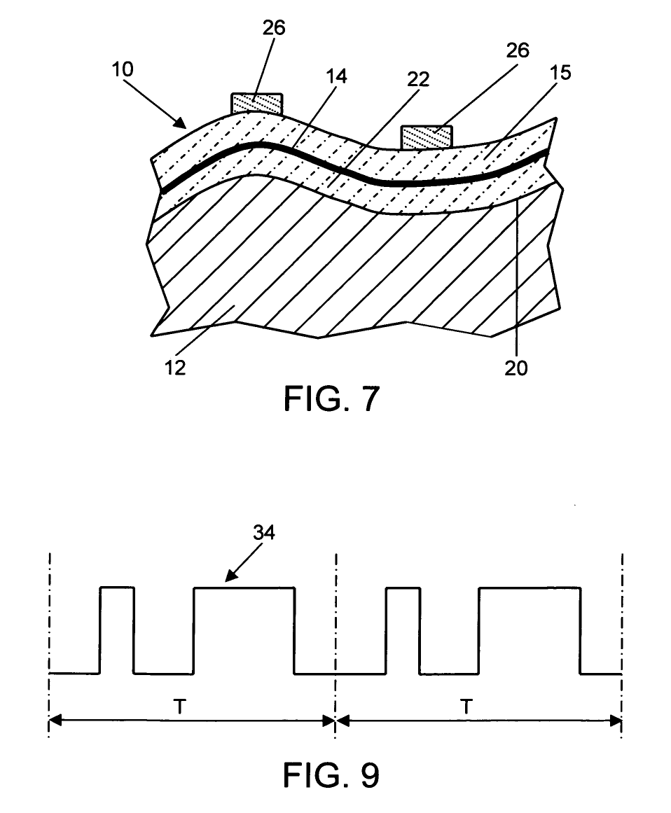

FIG. 6 is a diagrammatic partial sectional view of a further embodiment of a vehicle display configuration 10 according to the invention. The flexible LED display 14 is covered with protective layer 15 such as plastic or rubber material 15 in order to protect the flexible LED display 14 and is provided on the mounting surface 20 of the mounting layer 12. The flexible LED display 14 follows the surface contour of the mounting layer 12. A liner material 24 is provided on top of the flexible LED display 14 so that the flexible LED display 14 is mounted behind the liner material 24. The liner material 24 may for example be a vehicle roof liner material, the fabric of a seating surface, a vehicle floor liner material, a door panel material or a liner material that cover the dashboard, the A-pillar, B-pillar or C-pillar of the vehicle. Mounting the flexible LED display 14 behind a liner material 24 such as a fabric is advantageous if a diffuse light distribution or a specific aesthetic effect is desired. The LEDs may also be mounted behind a lens configuration in order to diffuse or focus light.

The LED display 14 may be mounted behind substantially any cloth or fabric surface such that it provides a hidden, distributed light source. Substantially any fabric surface can therefore be transformed into a lighting element. This allows improving the light distribution and light output.

FIG. 7 is a diagrammatic partial sectional view of a another embodiment of a vehicle display configuration 10 according to the invention. The flexible LED display 14, which is covered by a protective material 15, is provided on the mounting surface 20 of a mounting layer 12. Retaining clips 26 are used to clip the flexible LED display 14 to the mounting layer 12.

In the embodiments of the vehicle display configurations shown in FIGS. 5 to 7, the flexible LED display 14 is sufficiently bendable and pliable so that it follows the surface contour of the surface 20 on which it is mounted. As described above, various mounting methods may be used in order to fasten the flexible LED display 14. Also, the LED display 14 may be cast into an acrylic, plastic or rubber material prior to being fastened to the mounting layer 12.

As a result of the flexibility of the LED display 14 and the various mounting methods, it is possible to use the LED display 14 for accent lighting, indicator displays, warning lamps, ambient lighting, text displays, graphic displays, lighting for roof liners and floor liners, UV (ultraviolet) or IR (infrared) LED displays for thermal imaging, UV fluorescence of coated surfaces or as backlight for flexible displays. Further, color changing LEDs may be used as status indicators or for other visual displays. Other applications for the LED displays 14 described above are brake or parking lights, motion triggered warning lights and daylight running lights.

The physical flexibility of the LED display 14 allows installing LEDs and other integrated circuit components on substantially any surface of the vehicle interior or vehicle exterior. By using a thin polyamide material as a substrate for a printed circuit board, the circuitry can conform to any surface such as a curved surface of a window, a roofline, a seat, a door or any other vehicle surface which is not typically used for installing a lighting device or a display device due to the difficulty and expense of providing a stable mounting structure. As described above, the flexible circuit board 18 is preferably encased in a durable polyurethane rubber material which is formed and sealed around the flexible circuit board 18 and the circuit components on the flexible circuit board. As a result, the LED display is a washable, durable, light-weight, moisture-resistant display which can be used as a lighting element that serves, depending on the application, as a distributed, diffuse lighting element or, alternatively, as a focused lighting element.

Further applications of the LED display 14 are fabrics that have a flexible LED display 14 woven into the fabric. It is thus possible to integrate a display for example into the seat fabric of a vehicle. Another embodiment of the display includes a display on glass or polycarbonate and uses clear circuit traces made for example from indium tin oxide (ITO). This makes it possible to integrate a display into window glass. Due to the possibility of the display to conform to curved surfaces, it is possible to include conformal displays on gear shifters, door handles, keys and other objects. A substrate for coating organic LEDs with flexible plastic circuit components to improve component flexibility is also envisioned.

FIG. 8 is a schematic simplified circuit diagram for illustrating the layout and control of the LED display 14. The LED display 14 includes LEDs 16 and driver circuits 28 with shift registers for driving the LEDs 16. The LEDs 16 are connected to the driver circuits 28 and to a supply voltage VCC. The driver circuits 28 are connected to a microcontroller 30 via connecting lines 32 which are only schematically indicated as double arrows 32. The microcontroller 30 controls the driver circuits 28 and thus controls the LEDs 16. In the simplified schematic circuit diagram of FIG. 8 only three driver circuits 28 with shift registers are shown. The number of driver circuits 28 with shift registers can be increased in order to control a larger number of LEDs 16. Also, the simplified schematic circuit diagram of FIG. 8 has only a single LED 16 connected to each respective output of a driver circuit 28. Alternatively it is also possible to connect a series of LEDs 16 to each of the outputs of the shift registers of the driver circuits 28. Commercially available components may be used for the driver circuit 28 and the microcontroller 30. For the embodiment shown in FIG. 8, the LED driver MAX6968, which is available from MAXIM INTEGRATED PRODUCTS, INC., may be used. The microcontroller C8051F040, which is available from SILICON LABORATORIES, INC., may be used as the microcontroller shown in FIG. 8.

The driving of the embodiment of the LED display 14 shown in FIG. 8 operates as follows. The LED display 14 is controlled through serial communication to a series of 8-bit static shift registers of the driver circuits 28. The serial interface allows updating the shift registers with new data via a common synchronous protocol. The state of the eight LEDs 16 for each driver circuit 28 is controlled by receiving a single byte from a synchronous communication protocol. The shift registers of the driver circuits 28 are cascaded together so that a large number of outputs can be addressed. This method can be used to update the state of a number of LEDs 16, sending out new data whenever it is desired to change the state of an LED 16. The cascading of the driver circuits 28 allows driving an arbitrary number of LEDs.

The LED display utilizes high speed shift registers in order to update the state of an arbitrary number of LEDs 16 by transmitting a sequence of bytes hundreds of times per second. The transmitted sequence of bytes represents the brightness of each LED. The brightness of each LED 16 is controlled by cycling the on-off state of the LED 16 in a waveform 34 that is generated on the basis of a recurring interrupt pattern that is used for the LED display 14.

FIG. 9 is a graph illustrating an exemplary waveform 34 for controlling the on-off states of an LED 16. The waveform has a cycle period T which is chosen such that the on-off cycling of the LEDs is not perceivable to the human eye.

The brightness of each LED 16 is controlled by dividing the period T of the waveform 34 controlling a specific LED 16 into 2ⁿ−1 equally timed segments, with n being an integer. For illustrative purposes, this method is outlined here for a 6-bit resolution for the brightness of the LED which results in 63 (2⁶−1) equally timed segments. For 32/63 of the 63 (2⁶−1) segments of the controlling waveform, the value of the most significant bit (MSB) of resolution is transmitted and drives the output for the LED. Similarly, durations of 16/63, 8/63, 4/63, 2/63 and 1/63 of the total drive waveform frequency are transmitted and drive the output of the LED, following the state of each bit of the desired LED brightness. As stated above, by increasing the frequency of the overall control waveform, the on-off cycling of the LED is not perceivable by the human eye, and the result is a solid output of variable brightness.

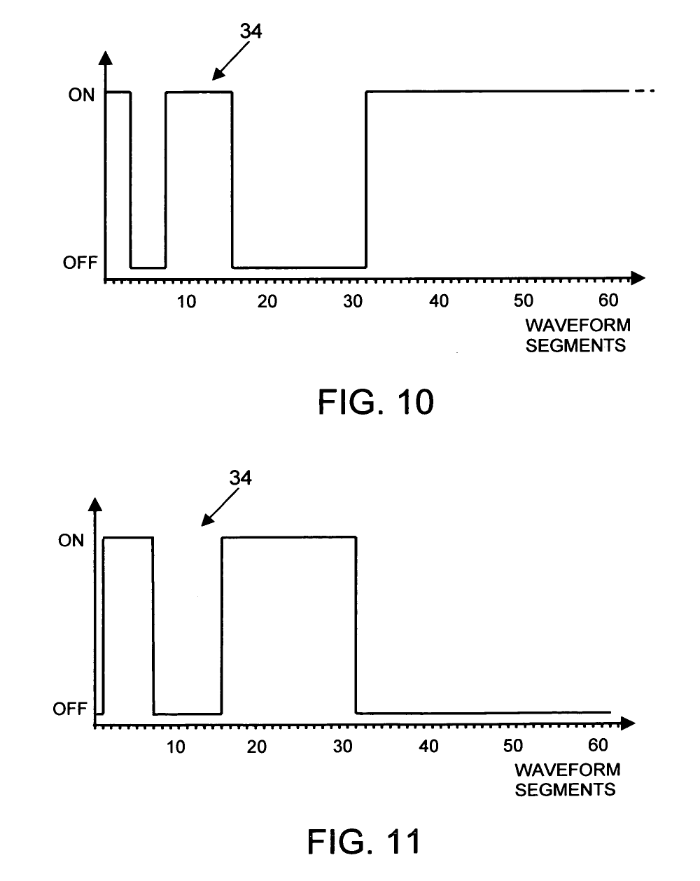

FIG. 10 is a graph illustrating a recurring interrupt pattern waveform 34 with a 6-bit resolution. The brightness value resulting from the interrupt pattern waveform shown in FIG. 10 is 68.75%. The frequency of the waveform is equivalent to the frequency of a pulse width modulation. The resolution of the waveform is 2ⁿ−1 times higher than the frequency of the pulse width modulation, i.e. the resolution of the waveform is 63 times higher than the frequency of the pulse width modulation for n=6.

FIG. 11 is a graph illustrating a further recurring interrupt pattern waveform 34 with a 6-bit resolution. The brightness value resulting from the interrupt pattern waveform shown in FIG. 11 is 34.375%. By having the waveform segmented into 63 segments, as in the exemplary embodiment shown in FIGS. 10 and 11, the LED display 14 is capable of creating 63 unique levels of brightness for any LED 16 within the display corresponding to approximately 6 bits of resolution (2⁶−1=63). The recurring interrupt pattern method is not limited to 6 bits of resolution. Rather, any number of bits of resolution may be developed in order to provide. a wide range of dimming values with the same display hardware.

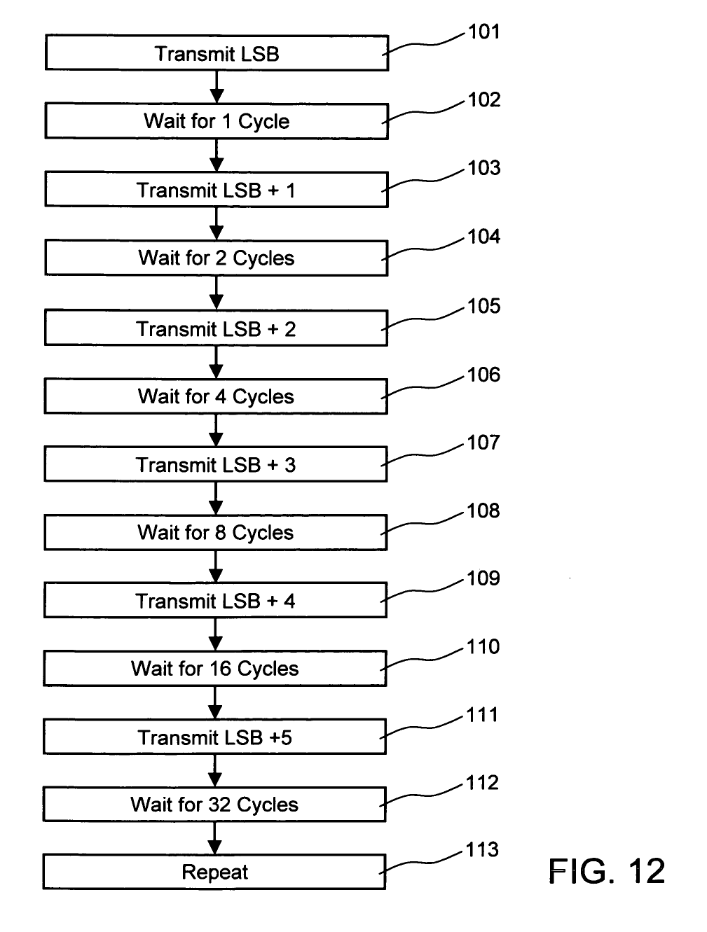

FIG. 12 is a flow chart clarifying the above-described method of creating various levels of brightness by using a recurring interrupt pattern waveform. In a first step 101, the least significant bit LSB is transmitted in order to control the LED. Next, there is a waiting step 102 which has a waiting time of one cycle period corresponding to the length of one waveform segment. In a following step 103, the next bit, namely LSB+1 is transmitted in order to control the LED. In step 104, a waiting time of two cycle periods is provided, after which the bit LSB+2 is transmitted in step 105. The method of generating the recurring interrupt pattern continues with corresponding waiting steps 106, 108, 110, 112 increasing the waiting time to respectively 4 cycle periods, 8 cycle periods, 16 cycle periods and finally 32 cycle periods. The waiting steps 106, 108, and 110 are respectively followed by steps 107, 109, and 111 in order to transmit the bits LSB+3, LSB+4, and LSB+5. After the last waiting step 112, the previous steps 101 to 112 are repeated (step 113) in order to provide a continuous control of the LED.

The method of creating the recurring interrupt pattern waveform by using a serial data control does not require any particular source to provide control over the display. Thus a dedicated controller, a PC (personal computer), a DSP (digital signal processor) or any other suitable controller may be used.

We Claim:

1. A vehicle display configuration, comprising:
a mounting layer having a surface shape;
an LED display including a flexible circuit board and a plurality of LEDs mounted on said flexible circuit board;
said flexible circuit board conforming to said surface shape of said mounting layer;
a control circuit including a driver circuit operatively connected to said LEDs for controlling said LEDs;
said driver circuit having a serial data input and a shift register, said driver circuit shifting data received via said serial data input into said shift register; and
said driver circuit controlling said LEDs in accordance with the data in said shift register.

2. The vehicle display configuration according to claim 1, wherein said control circuit includes a microcontroller connected to said driver circuit for sending data to said serial data input of said driver circuit.

3. The vehicle display configuration according to claim 1, wherein said driver circuit is an integrated circuit mounted on said flexible circuit board.

4. The vehicle display configuration according to claim 1, wherein:
said driver circuit is a first driver circuit connected to a first group of said LEDs mounted on said flexible circuit board;
said control circuit includes a microcontroller and includes a second driver circuit connected to a second group of said LEDs mounted on said flexible circuit board;
said first driver circuit and said second driver circuit each have a serial data input, a serial data output and a shift register;
said serial data input of said first driver circuit is connected to said microcontroller for receiving data from said microcontroller;
said serial data input of said second driver circuit is connected to said serial data output of said first driver circuit for receiving data cascaded through said first driver circuit;
said first driver circuit and said second driver circuit respectively shift data received via said serial data input into said shift register; and
said first driver circuit and said second driver circuit respectively control said first group and said second group of said LEDs in accordance with the data in said shift register.

5. The vehicle display configuration according to claim 1, wherein said control circuit adjusts a brightness of said LEDs by switching said LEDs on and off in a recurring pattern.

6. The vehicle display configuration according to claim 1, wherein said flexible circuit board is coated with a protective material selected from the group consisting of polyurethane, acrylic, plastic, rubber and an electromagnetic interference shielding material.

7. The vehicle display configuration according to claim 1, including:
a liner material at least partially covering said LED display, said LEDs emitting light through said liner material; and
said liner material being selected from the group consisting of a vehicle roof liner material, a vehicle seat cover material, a vehicle interior panel material and a vehicle dashboard material.

8. The vehicle display configuration according to claim 1, wherein said flexible circuit board is fastened to said mounting layer with a fastening element selected from the group consisting of a retaining clip, a hook and loop fastener, and an adhesive.

9. The vehicle display configuration according to claim 1, wherein said mounting layer is translucent and said flexible circuit board includes translucent lead lines.

10. The vehicle display configuration according to claim 1, wherein said mounting layer is a vehicle component selected from the group consisting of a gear shifter, a door handle and a vehicle key.

11. The vehicle display configuration according to claim 1, including an electronic element selected from the group consisting of a push button and a sensor element mounted on said flexible circuit board.

12. The vehicle display configuration according to claim 1, wherein said flexible circuit board is configured to have no through-hole components mounted thereon.

13. A method of controlling a display, the method which comprises:
providing cycle periods and controlling an LED by switching the LED at each cycle period selectively into an on-state and an off-state;
providing N bits for controlling the on-state and the off-state of the LED, N being an integer greater than 2;
controlling the on-state and the off-state of the LED by repeatedly performing steps a) and b) starting with n=1 and increasing n by 1 until n=N:
a) selectively switching the LED into an on-state and an off-state in accordance with an n−th one of the N bits; and
b) waiting for a time period corresponding to 2ⁿ⁻¹ cycle periods.

14. The method of controlling a display according to claim 13, which comprises:
creating a recurring interrupt pattern waveform by continuously repeating the steps a) and b) for n=1 to n=N; and
using the recurring interrupt pattern waveform for continuously controlling the LED.
